(19) United States
(12) Patent Application Publication
(10) Pub. No.: US 2011/0169693 A1
(43) Pub. Date: Jul. 14, 2011

(54) INTEGRITY COMMUNICATION IN A SATELLITE NAVIGATION SYSTEM

(75) Inventor: Hans L. TRAUTENBERG, Ottobrunn (DE)

(73) Assignee: ASTRIUM GMBH, Taufkirchen (DE)

(21) Appl. No.: 13/005,115

(22) Filed: Jan. 12, 2011

(30) Foreign Application Priority Data
Jan. 13, 2010 (DE) 102010004617.5-55

(51) Int. Cl. G01S 19/20

(52) U.S. Cl. 342/357.58

(57) ABSTRACT

Embodiments of the invention are directed to a method for integrity communication in a satellite navigation system having a space segment with several satellites transmitting navigation signals for reception and evaluation by use systems for position determination, and a ground segment with several observation stations that, in their totality, monitor the satellites and their signals, and including at least one transmitting station. The method includes detecting errors that one of have or could have occurred in a determination of a pseudo-range between the satellites and the observation stations and could influence the integrity of the satellite navigation system, forming, from the detected errors, three error budgets for respectively different categories of errors that one of have or could have occurred in the determination of the pseudo-range between the satellites and the observation stations, transmitting the three error budgets one of per ground station or for a group of ground stations with a navigation signal of at least one satellite to the use systems, and receiving the navigation signal and estimating the integrity of the satellite navigation system by evaluating the error budget contained in the received navigation signal

### CROSS-REFERENCE TO RELATED APPLICATIONS

The present application claims priority under 35 U.S.C. §119 of German Patent Application No. 10 2010 004 617.5-55, filed on Jan. 13, 2010, the disclosure of which is expressly incorporated by reference herein in its entirety.

### BACKGROUND OF THE INVENTION

1. Field of the Invention

Embodiments of the invention are directed to a method for improving integrity communication in a satellite navigation system that has a space segment with several satellites that transmit navigation signals for reception and evaluation by use systems for position determination, and a ground segment with several observation stations, which in their totality monitor the satellites and their signals, and has at least one transmitting station. Further embodiments of the invention are directed to a device for integrity communication in a satellite navigation system, which has a space segment with several satellites that transmit navigation signals for reception and evaluation by use systems for position determination, and a ground segment with several observation stations, which in their totality monitor the satellites and their signals, and at least one transmitting station.

2. Discussion of Background Information

Patent application DE 10 2007 050 716 (and counterpart U.S. Patent Application Publication No. US 2009/135055) describes how the integrity communication in a satellite navigation system can be improved in that for the different observation stations of a satellite navigation system, or for groups of observation stations of a satellite navigation system, error budgets are transmitted to use systems from which then a scalar value in particular of individual use systems can be calculated that gives the accuracy of the error estimate of the production of the navigation signal. The scalar values that individual use systems use can thereby be much smaller, since a scalar value can be calculated by a use system in a locus-dependent manner and the maximum for all use systems no longer needs to be calculated in a central unit of the satellite navigation system and transmitted to the use systems. In Galileo, this scalar value is referred to as the SISMA. Moreover, through the calculation of the scalar value in a use system, continuity demands of individual use systems can also be taken into account, whereby the highest demands on continuity no longer need to be met by each use system. The disclosures of German Patent Application No. DE 10 2007 050 716 and of U.S. Patent Application Publication No. US 2009/135055 are expressly incorporated by reference herein in their entireties.

### SUMMARY OF THE INVENTION

Embodiments of the present invention are directed to integrity communication in a satellite navigation system.

According to embodiments, a method for improving integrity communication in a satellite navigation system includes determination of errors that have or could have occurred in a determination of a pseudo-range between the satellites and the observation stations and could influence integrity of the satellite navigation system, formation of three error budgets for respectively different categories of errors that have or could have occurred in the determination of the pseudo-range between the satellites and the observation stations, from the detected errors, transmission of the three error budgets either per ground station or for a group of ground stations with a navigation signal of at least one satellite to use systems, and reception of the navigation signal and estimation of the integrity of the satellite navigation system by evaluation of the error budget contained in the navigation signal received.

According to further embodiments, a device for improving integrity communication in a satellite navigation system includes a device for determining errors which have or could have occurred in a determination of a pseudo-range between the satellites and the observation stations and can influence the integrity of the satellite navigation system, a device for forming three error budgets for respectively different categories of errors, which have or could have occurred in the determination of the pseudo-range between the satellites and the observation stations, from the detected errors, and a device for transmitting the three error budgets either per ground station or for a group of ground stations to satellites of the satellite navigation system for distribution to use systems. Further embodiments of the invention are the subject matter of the dependent claims.

A preferred concept of the present invention is that in the determination of the pseudo-range between the satellites and the observation stations, three error budgets for respectively different categories of errors are transmitted by the satellite navigation system to use systems. These error budgets can be combined in a use system in order to be able to detect or determine the integrity of the satellite navigation system even more precisely than heretofore possible. Through the transmission of these three error budgets, the integrity communication and integrity determination in a satellite navigation system and the integrity determination in a use system can be further improved.

In a particular embodiment, integrity communication can be improved through a method in a satellite navigation system that has a space segment with several satellites that transmit navigation signals for reception and evaluation by use systems for position determination, and a ground segment with several observation stations, which in their totality monitor the satellites and their signals, and at least one transmitting station. The method includes a determination of errors that have occurred or could have occurred in the determination of the pseudo-range between the satellites and the observation stations and could influence the integrity of the satellite navigation system, formation of three error budgets for respectively different categories of errors that have occurred or could have occurred in the determination of the pseudo-range between the satellites and the observation stations, from the detected errors that occurred or could have occurred in the determination of the pseudo-range between the satellites and the observation stations, transmission of the three error budgets either per ground station or for group of ground station with a navigation signal of at least one satellite to use systems, and reception of the navigation signal and estimation of the integrity of the satellite navigation system by evaluation of the error budget contained in the navigation signal received.

In accordance with embodiments, the three error budgets can have the following error budgets: A first error budget, in which all correlated error contributions at distance estimates from different satellites at an observation station at one time are combined; a second error budget, in which all uncorrelated error contributions at distance estimates from different satellites at an observation station at one time are combined; and a third error budget for the error contributions, about the correlation of which no statement can be made.

The first error budget can have errors in the modeling of the dry troposphere, particularly, when the troposphere has no strong gradients over a large area.

The second error budget can have errors due to the moist portion of the troposphere and/or errors due to multi-path propagation effects of the navigation signals.

The third error budget can have errors that occur through the reception in the individual channels in the receiver in the observation station.

In a further embodiment, the invention relates to a use system for a satellite navigation system, in particular, a mobile navigation device, which is designed for use with the method according to the above-described embodiment of the invention.

The use system can furthermore be embodied or formed to estimate the integrity of the satellite navigation system from received error budgets and to determine an integrity risk therefrom.

Finally, another embodiment the invention relates to a device for improving the integrity communication in a satellite navigation system, which has a space segment with several satellites that transmit navigation signals for reception and evaluation by use systems for position determination, and a ground segment with several observation stations, which in their totality monitor the satellites and their signals, and at least one transmitting station. The device includes a device for determining errors which have occurred or could have occurred in the determination of the pseudo-range between the satellites and the observation stations and can influence the integrity of the satellite navigation system, a device for forming three error budgets for respectively different categories of errors, which have occurred or could have occurred in the determination of the pseudo-range between the satellites and the observation stations, from the detected errors, and a device for transmitting the three error budgets either per ground station or for group of ground station to satellites of the satellite navigation system for distribution to use systems.

The devices can be implemented in software and/or hardware. The device can be arranged centrally in a control center of the ground segment or distributed among several components of the ground segment.

The terms used in the list of reference numbers attached at the end and assigned reference numbers are used in the specification, in the claims, in the abstract and in the drawings.

Embodiments of the invention are directed to a method for integrity communication in a satellite navigation system having a space segment with several satellites transmitting navigation signals for reception and evaluation by use systems for position determination, and a ground segment with several observation stations that, in their totality, monitor the satellites and their signals, and including at least one transmitting station. The method includes detecting errors that one of have or could have occurred in a determination of a pseudo-range between the satellites and the observation stations and could influence the integrity of the satellite navigation system, forming, from the detected errors, three error budgets for respectively different categories of errors that one of have or could have occurred in the determination of the pseudo-range between the satellites and the observation stations, transmitting the three error budgets one of per ground station or for a group of ground stations with a navigation signal of at least one satellite to the use systems, and receiving the navigation signal and estimating the integrity of the satellite navigation system by evaluating the error budget contained in the received navigation signal.

According to aspects of the embodiments, the three error budgets can include a first error budget, in which all correlated error contributions at distance estimates from different satellites at an observation station at one time are combined, a second error budget, in which all uncorrelated error contributions at distance estimates from different satellites at an observation station at one time are combined, and a third error budget for the error contributions, about the correlation of which no statement can be made. Further, the first error budget may include errors in a modeling of a dry troposphere. The dry troposphere has no strong gradients over a large area. Still further, the second error budget can include at least one of errors due to a moist portion of a troposphere and errors due to multi-path propagation effects of the navigation signals. Moreover, the observation station can include a receiver having individual channels, and the third error budget includes errors that occur through a reception in the individual channels in the receiver in the observation station.

In accordance with other aspects of the embodiments, a use system for a satellite navigation system can be structured and arranged to receive signals in accordance with the above-described methods. Moreover, the use system can be a mobile navigation device. The use system may be structured and arranged to estimate the integrity of the satellite navigation system from error budgets received and to determine an integrity risk therefrom.

Embodiments of the instant invention are directed to a device for integrity communication in a satellite navigation system having a space segment with several satellites that transmit navigation signals for reception and evaluation by use systems for position determination, a ground segment with several observation stations that, in their totality, monitor the satellites and their signals, and including at least one transmitting station. The device includes a detector for detecting errors that one of have or could have occurred in the determination of a pseudo-range between the satellites and the observation stations and can influence the integrity of the satellite navigation system, a former for forming, from the detected errors, three error budgets for respectively different categories of errors, which one of have or could have occurred in the determination of the pseudo-range between the satellites and the observation stations, and a transmitter for transmitting the three error budgets either per ground station or for group of ground station to satellites of the satellite navigation system for distribution to the use systems.

In accordance with still yet other aspects of the embodiments of the present invention, the former may include a unit for forming a first error budget that includes a device for combining all correlated error contributions at distance estimates from different satellites at an observation station at one time, a unit for forming a second error budget that includes a device for combining all uncorrelated error contributions at distance estimates from different satellites at an observation station at one time, and a unit for forming a third error budget for the error contributions, about the correlation of which no statement can be made. The first error budget can include errors in a modeling of a dry troposphere. Further, the dry troposphere may have no strong gradients over a large area. The second error budget can include at least one of errors due to a moist portion of a troposphere and errors due to multi-path propagation effects of the navigation signals. Still further, the observation station may include a receiver having individual channels, and the third error budget includes errors that occur through a reception in the individual channels in the receiver in the observation station.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein

FIG. 1 illustrates a satellite navigation system with an exemplary embodiment of a device for improving the integrity communication in a satellite navigation system according to the invention; and

FIG. 2 illustrates a flow chart of an exemplary embodiment of a method for improving the integrity communication in a satellite navigation system according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Satellite systems for worldwide navigation, known as Global Navigation Satellite System (GNSS) or satellite navigation system, for short, are used for position determination and navigation on earth and in the air. GNSS systems, such as, e.g., the European Satellite Navigation System, also known as the Galileo System or Galileo, for short, currently being constructed, have a satellite system (or space segment) having a plurality of satellites, an earth-fixed receiving device system (or ground segment) connected to a central computing station, which includes several ground stations as well as Galileo sensor stations (or observation stations), as well as use systems, which evaluate and use the satellite signals transmitted by radio from the satellites, in particular, for navigation.

In a GNSS, a precise detection of the position of a user requires local as well as global integrity. In this regard, integrity means that the GNSS is capable of warning a user within a specific time period when parts of the GNSS should not be used for navigation, e.g., in the event of the failure of system components, and that the user can trust the navigation data received via satellite navigation signals from the GNSS satellites and particularly can rely upon the precision of the navigation data received.

In the integrity concept of Galileo, it is planned to monitor each satellite from an earth-fixed receiving device system and to transmit corresponding message signals regarding the behavior of each satellite to use systems, e.g., an estimated signal-in-space accuracy (SISA) of a satellite or a simple error indication “Not OK” in the case of a faulty satellite. This integrity information is transmitted with the navigation signals.

According to embodiments, Galileo can also capable of monitoring the signal-in-space (SIS), i.e., the navigation signal transmitted by the satellites, in the ground segment by using measurements from individual Galileo sensor stations. With the aid of the known positions of the Galileo sensor stations, the current position of the direction-dependent phase center of a satellite and thus the maximum error of the satellite or of the signal-in-space transmitted by it, the so-called signal-in-space error (SISE) can then be estimated.

A prediction of the distribution of the SISE can be represented by a Gaussian distribution with the smallest standard deviation, such that this representation can include an overbound. The standard deviation of this Gaussian distribution is referred to as a signal-in-space accuracy (SISA). With the SISA, the difference between the current 4-dimensional position (orbit and time) of a satellite and the predicted 4-dimensional position that is contained in a navigation message can be described.

However, the estimation of the SISE is an error-prone process. It is therefore generally assumed that the distribution of the current SISE around the value of the estimated SISE can be described by a Gaussian distribution with the standard deviation, which is referred to as the signal-in-space monitoring accuracy (SISMA). The SISMA is therefore the accuracy of the estimation of the SISE for a satellite.

With the previous concept of Galileo for the transmission of the SISMA, a scalar value is transmitted for each satellite, which is conservative for every possible position of a use system (user position). As a result, however, much of the efficiency of the GNSS is wasted, since in many positions a clearly excessive value is transmitted, which leads to a complex integrity communication in the GNSS.

Since the individual observation stations or the communication between the individual ground station and the central processing location have a relatively high failure probability, it is necessary to take into account possible failures of ground stations in advance when calculating the scalar value, such that a sufficiently large number of failures must be taken into account so that even the strictest continuity demands can be met. However, this consideration again leads to a clearly excessive value for the scalar value, in particular, for use systems that do not have such high demands on continuity. In addition, for computing the scalar value for each satellite, the worst observation station is omitted, which is clearly more conservative than is often necessary.

Furthermore, it has not heretofore been taken into consideration that in estimating the errors of estimation, correlated errors between measurements have a different effect from uncorrelated errors. The integrity communication, however, can be much improved if the different effects of errors of different categories are transmitted to use systems as proposed by the present invention.

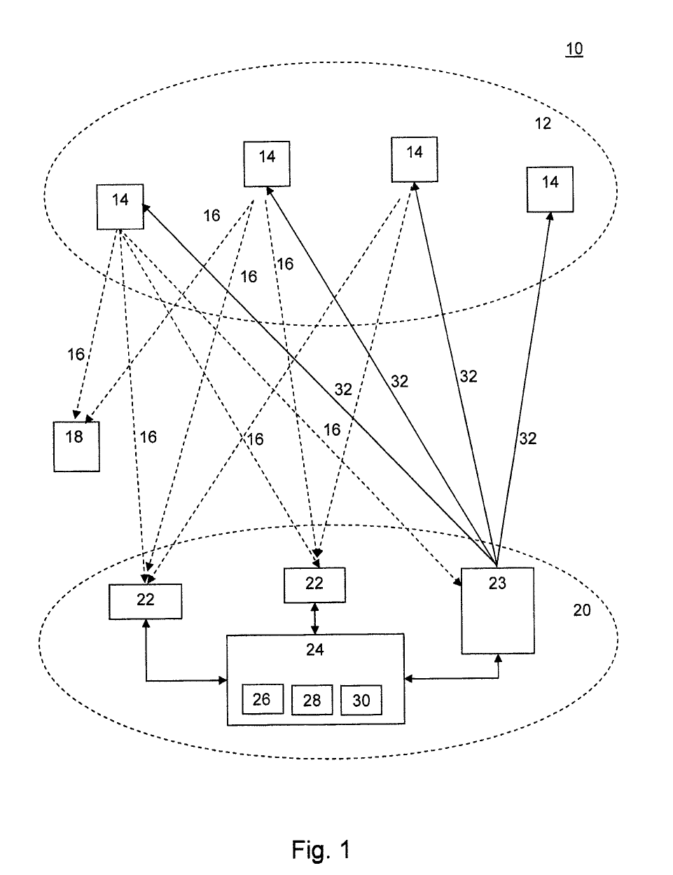

To illustrate the integrity communication, FIG. 1 shows an example of a satellite navigation system 10 with a space segment 12 and a ground segment 20. Space segment 12 can include several satellites 14, which orbit ground segment 20 on their respective orbits. Each satellite 14 transmits navigation signals 16, which can be received by use systems 18, such as, e.g., mobile navigation devices, and by observation stations 22 of ground segment 20. Observation stations 22 are provided in particular for monitoring satellites 14 and coordinating the integrity communication in satellite navigation system 10. To this end, observation stations 22 evaluate the received navigation signals 16 or carry out measurements to verify the data of a satellite 14 transmitted with each navigation signal 16, in particular, the orbit and time of the signal generation and signal structure. A transmitting station 23 can also transmit control messages 32 to satellites, e.g., in order to cause a correction of satellite data or in order to influence the integrity communication in the satellite navigation system 10, which is described in further detail below. Observation stations 22, as well as transmitting stations 23, are coupled in terms of communication with a central device 24 for improving the integrity communication in satellite navigation system 10.

Device 24 can include a detector or detection device 26 for errors influencing the integrity of the satellite navigation system, an error budget former or error budget formation device 28 and error budget transmitter or error budget transmission device 28.

The detector 26 detects all errors which have or could have occurred in the determination of a pseudo-range between the satellites 14 and the observation stations 22 and which can influence the integrity of satellite navigation system 10. The errors can include: errors in the modeling of the dry troposphere, particularly, when the troposphere does not have any large gradients over a large area; errors due to a moist portion of the troposphere; errors due to multi-path propagation effects of the navigation signals; clock synchronization errors of the observation stations; and errors in the orbit estimation and time estimation.

The error budget former 28 can be structured and arranged to form three different categories of errors (or error budgets) from the detected errors. These error budgets can include: a first error budget in which all correlated error contributions with distance estimates to different satellites at a ground station at one time are combined, such that this category includes, e.g., the errors in modeling of the dry troposphere and the clock synchronization errors of the observation stations; a second error budget in which all uncorrelated error contributions with distance estimates from different satellites at a ground station at one time are combined, such that this category includes, e.g., the errors due to the moist portion of the troposphere and the errors due to multi-path propagation effects of the navigation signals; and a third error budget for the error contributions about the correlation of which no statement can be made, such that this category regularly includes, e.g., the errors that occur due to the reception in the individual channels in the receiver in the observation station.

The error budgets thus formed may then be transmitted by error budget transmitter 28 of device 24 to transmitting stations 23, and transmitting stations 23 in turn transmit the error budgets to satellites 14 with, e.g., a control message 32 to be distributed with navigation signals 16 of satellites 14 to use systems 18. Through the differentiation of errors by the three error budgets, the integrity communication in satellite navigation system 10 can be improved, because it becomes possible for use systems 18 to more accurately distinguish between observation errors at observation stations 22 impairing the integrity of satellite navigation system 10 and influencing errors in the calculation of the observation accuracy by device 24 for improving the integrity communication and particularly in detector 26. Thus, use system 18 can better estimate the integrity of a received satellite navigation signal. Each use system 18, which receives a satellite navigation signal 16 with the three error budgets, can estimate, above all based on the error budgets, the efficiency of the satellite navigation system, with respect to the accuracy of the navigation signal (SISA) and regarding the accuracy of the error estimate of the navigation signals (SISMA) by the ground segment, i.e., the integrity. The improvement can be significant for the estimation of the latter.

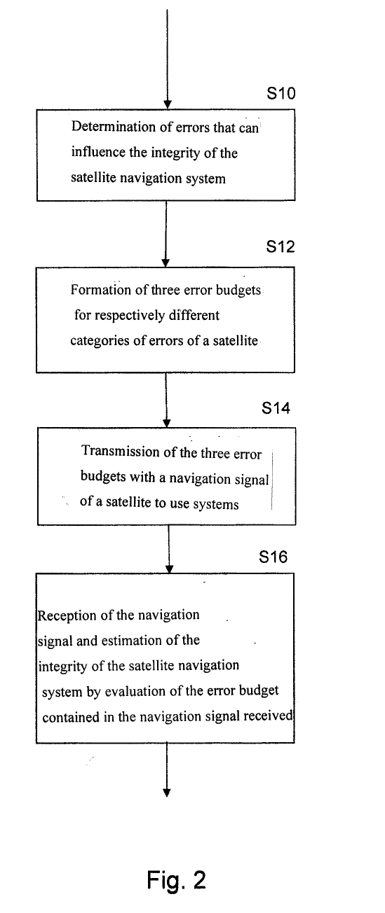

In FIG. 2, the sequence of a method for improving the integrity communication in the satellite navigation system 10 according to embodiments of the invention is illustrated. In a first step S10, the errors that can influence the integrity of the satellite navigation system are determined or detected. Subsequently, in step S12 three error budgets for respectively different categories of errors are formed from the detected errors. In following step S14, the three error budgets are initially transmitted to the satellites, which in turn transmit it back with their navigation signals to the ground segment for evaluation by use systems. In step S16, a navigation signal of a satellite is received by a use system and the error budgets contained therein are evaluated by the use system in order to estimate the integrity of the satellite navigation system. In the last step, the use system can add in particular the errors of the third error budget either to the first or to the second error budget, depending on which of the two error budgets produces a more conservative estimate of the efficiency and particularly integrity of the satellite navigation system.

Based on the present invention, in particular the scalar values for the accuracy of the error estimate (SISMA), which individual use systems use for the integrity review, can be smaller without more hardware having to be installed, since the modeling can be carried out with more accuracy.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### REFERENCE NUMBERS

10 Satellite navigation system
12 Space segment
14 Satellites
16 Navigation signals
18 Use systems
20 Ground segment
22 Observation stations
23 Transmitting stations
24 Device for improving the integrity communication in a satellite navigation system
26 Detector for errors influencing the integrity of the satellite navigation system
28 Error budget former
30 Error budget transmitter
32 Control message of a transmitting station 23
S10-S16 Process steps

What is claimed:

1. A method for integrity communication in a satellite navigation system having a space segment with several satellites transmitting navigation signals for reception and evaluation by use systems for position determination, and a ground segment with several observation stations that, in their totality, monitor the satellites and their signals, and including at least one transmitting station, the method comprising:
detecting errors that one of have or could have occurred in a determination of a pseudo-range between the satellites and the observation stations and could influence the integrity of the satellite navigation system;
forming, from the detected errors, three error budgets for respectively different categories of errors that one of have or could have occurred in the determination of the pseudo-range between the satellites and the observation stations;
transmitting the three error budgets one of per ground station or for a group of ground stations with a navigation signal of at least one satellite to the use systems; and
receiving the navigation signal and estimating the integrity of the satellite navigation system by evaluating the error budget contained in the received navigation signal.

2. The method in accordance with claim 1, wherein the three error budgets comprise:
a first error budget, in which all correlated error contributions at distance estimates from different satellites at an observation station at one time are combined;
a second error budget, in which all uncorrelated error contributions at distance estimates from different satellites at an observation station at one time are combined; and
a third error budget for the error contributions, about the correlation of which no statement can be made.

3. The method in accordance with claim 2, wherein the first error budget includes errors in a modeling of a dry troposphere.

4. The method in accordance with claim 3, wherein the dry troposphere has no strong gradients over a large area.

5. The method in accordance with claim 2, wherein the second error budget includes at least one of errors due to a moist portion of a troposphere and errors due to multi-path propagation effects of the navigation signals.

6. The method in accordance with claim 2, wherein the observation station includes a receiver having individual channels, and the third error budget includes errors that occur through a reception in the individual channels in the receiver in the observation station.

7. A use system for a satellite navigation system, the use system being structured and arranged to receive signals in accordance with the method of claim 1.

8. The use system in accordance with claim 7 being a mobile navigation device.

9. The use system in accordance with claim 7 being structured and arranged to estimate the integrity of the satellite navigation system from error budgets received and to determine an integrity risk therefrom.

10. A device for integrity communication in a satellite navigation system having a space segment with several satellites that transmit navigation signals for reception and evaluation by use systems for position determination, a ground segment with several observation stations that, in their totality, monitor the satellites and their signals, and including at least one transmitting station, the device comprising:
a detector for detecting errors that one of have or could have occurred in the determination of a pseudo-range between the satellites and the observation stations and can influence the integrity of the satellite navigation system;
a former for forming, from the detected errors, three error budgets for respectively different categories of errors, which one of have or could have occurred in the determination of the pseudo-range between the satellites and the observation stations; and
a transmitter for transmitting the three error budgets either per ground station or for group of ground station to satellites of the satellite navigation system for distribution to the use systems.

11. The device in accordance with claim 10, wherein the former comprises:
a unit for forming a first error budget that includes a device for combining all correlated error contributions at distance estimates from different satellites at an observation station at one time;
a unit for forming a second error budget that includes a device for combining all uncorrelated error contributions at distance estimates from different satellites at an observation station at one time; and
a unit for forming a third error budget for the error contributions, about the correlation of which no statement can be made.

12. The device in accordance with claim 11, wherein the first error budget includes errors in a modeling of a dry troposphere.

13. The device in accordance with claim 12, wherein the dry troposphere has no strong gradients over a large area.

14. The device in accordance with claim 11, wherein the second error budget includes at least one of errors due to a moist portion of a troposphere and errors due to multi-path propagation effects of the navigation signals.

15. The method in accordance with claim 11, wherein the observation station includes a receiver having individual channels, and the third error budget includes errors that occur through a reception in the individual channels in the receiver in the observation station.
